(19) United States
(12) Patent Application Publication
(10) Pub. No.: US 2014/0175908 A1
(43) Pub. Date: Jun. 26, 2014

(54) METHOD OF REGULATING THE POWER OF AN ENERGY CONVERSION INSTALLATION AND ENERGY CONVERSION INSTALLATION DRIVEN BY SUCH A METHOD

(71) Applicant: ALSTOM Renewable Technologies, Grenoble (FR)

(72) Inventor: Guillaume BATS, Nantes Cedex (FR)

(73) Assignee: ALSTOM Renewable Technologies, Grenoble (FR)

(21) Appl. No.: 14/136,265

(22) Filed: Dec. 20, 2013

Related U.S. Application Data
(63) Continuation of application No. PCT/EP2012/062122, filed on Jun. 22, 2012.

(30) Foreign Application Priority Data
Jun. 23, 2011 (FR) 1155559

(51) Int. Cl. F03D 9/00

(52) U.S. Cl. CPC F03D 9/003
USPC 307/151

(57) ABSTRACT

This method makes it possible to regulate the power of an energy conversion installation (100) for converting mechanical energy into electrical energy. The installation (100) comprises a machine (1), an alternator (2), a first converter (41), an electrical cable (3) which links the terminals of the alternator (2) to the first converter (41), a second converter (42), means of measurement (8, 41, 43), a control unit (5), the first converter (41) modulating the frequency and the current of the first electrical signal (S2). The method comprises a first prior step in which the value of a first quantity proportional to a reactive power is implemented in the control unit and a main step in which the control unit (5) determines the drive frequency and the drive current on the basis of an error equal to the difference between the first quantity and a second quantity which is both homogeneous to the first quantity, dependent on the reactive power of the first converter (41) and determined on the basis of a measured value of the current of the first electrical signal (S2).

The present invention relates to a method for regulating the power of an installation for the conversion of mechanical energy into electrical energy, as well as an installation driven by such a method.

In the context of the present invention, the installation comprises a machine able to be a hydraulic turbine, for example a marine turbine, or a wind turbine. The machine comprises a rotary mechanical receiver intended to be traversed by a flow of water or air. Depending on the type of machine, the receiver is generally denoted by the term “propeller” or “wheel”. Hereafter, the receiver is denoted by the term “propeller”. The propeller comprises blades fixed to a hub which is connected to an alternator. When in service, the flow rotationally drives the propeller and the alternator converts the mechanical power generated by the rotation of the propeller into electrical power. Thus, the assembly formed by the machine and the alternator form an electrical energy generator.

In order to be able to directly couple the alternator to the electrical network, the frequency of the sinusoidal electrical signal at the output of the alternator must be equal to the frequency of the electrical network, for example 50 Hz in Europe or 60 Hz in the United States. Now, the frequency of the electrical signal delivered by the alternator varies as a function of the speed of rotation of the propeller and when the installation is operating, the speed and the pressure of the flow fluctuate, thereby causing the speed of rotation of the propeller to vary. Consequently, the alternator cannot be connected directly to the electrical network.

To enable the alternator to be coupled to the electrical network, a known technique is to equip the installation with an electrical energy converter, the input of which is connected to the output of the alternator and the output of which is intended to be connected to the electrical network. The converter modulates certain parameters of the electrical signal delivered by the alternator and sends the electrical energy of the electrical signal delivered by the alternator to the electrical network via an electrical signal having a frequency equal to the frequency of the electrical network. More specifically, the converter modulates the intensity of the current and the phase between the current and the voltage of the electrical signal delivered by the alternator, thereby making the quantity of electrical energy delivered by the alternator vary. This is because the electrical energy delivered by the alternator varies as a function of the current of the electrical signal delivered by the alternator. If the electrical current delivered by the alternator is nil, then there is no electrical energy delivered by the alternator.

In order that the alternator operates at its optimal operating point, the electromagnetic fields of the stator and the rotor of the alternator must be in phase. Specifically, if these electromagnetic fields are out of phase, in other words if an angle Ψ between these electromagnetic fields is not nil, then the alternator does not operate at its optimal operating point, thereby reducing the performance and efficiency of the installation. The efficiency of installation does not only depend on the angle Ψ between the electromagnetic fields.

When in operation, the converter controls the intensity of an electromagnetic braking torque applied to the rotor of the alternator. Each rotation speed of the propeller is associated with an optimal electromagnetic torque enabling the hydraulic machine or wind turbine to extract a maximum of mechanical energy from the flow. By making the parameters of the electrical signal vary at its terminals, the converter modulates the intensity of the electrical current delivered by the alternator, and consequently also modulates the electromagnetic braking torque, thereby modifying the speed of rotation of the propeller. The speed can thus be adjusted to a value to maximize the mechanical energy converted. The control of the electromagnetic braking torque therefore provides for optimizing the efficiency of the installation. The efficiency of the installation is all the more improved as the alternator functions at its optimal operating point.

Conventionally, installations comprise a control unit which drives the converter so as to make the intensity of the electromagnetic braking torque vary as a function of the fluctuations of the flow, thereby enabling the propeller to retrieve a maximum amount of mechanical energy from the kinetic energy of the flow. Thus, the efficiency of the installation is optimized.

With the aim of making the installation operate at its maximum efficiency, a known technique is to equip the alternator with a position sensor which detects the angular position of the rotor relative to the stator. For example, this can be a Hall effect sensor which delivers a digital signal upon each change of polarity of the magnetic field of the alternator. The control unit calculates the angular position of the stator as a function of the signal delivered by the sensor and drives the converter according to this information so as to cancel the angle Ψ between the rotoric and statoric electromagnetic fields. The sensors are sources of failure, and when they break down, the installation can no longer operate. Consequently, it is necessary to regularly carry out maintenance of the installation, which is expensive. In particular, in the case of marine turbines, maintenance is complicated since it can require taking the machine out of the water in order to intervene.

US-A-2003/081434 discloses a method for regulating the power of an installation for the conversion of mechanical energy into electrical energy, by estimating the angular position of the rotor of the alternator. US-A-2003/081434 does not concern installations comprising a rotary mechanical receiver intended to be traversed by a flow.

Alternative solutions not requiring the use of mechanical sensors provide for driving the converter in order to make the alternator operate at its optimal operating point. A mechanical sensor is understood to mean a sensor which detects the physical position of a part. For example, methods for driving the converter are known which use nominal characteristics of the alternator such as the open-circuit voltage, the resistance and the inductance of the stator. For example, methods called “observer” or “numerical model” are known. These driving methods do not always enable the installation to start up since the propeller must reach a minimum rotation speed for the method to operate. Moreover, the impedance of the electric cables can significantly modify the resistance and inductance of the stator. Now, the resistance of the electric cables varies as a function of temperature, which is difficult to take into account in such a method. Thus these methods are not very suitable for marine turbines since there can be a long distance between the converter and the alternator, with large variations in temperature too. For this reason, long-length electric cables convey the electrical signal between the alternator and the converter.

It is these drawbacks which the invention more particularly intends to remedy, by proposing a method for regulating the power of an installation for the conversion of mechanical energy into electrical energy not requiring the use of mechanical sensors or complex numerical models or depending on variable parameters. The method of the invention is simple to program, does not require significant computational resources and is not sensitive in a significant way to variations in external parameters such as temperature. Another aim of the invention is to propose a method suitable for starting up the installation when the turbine is at rest.

To this end, a subject of the invention is a method for regulating the power of an installation for the conversion of mechanical energy into electrical energy as defined in claim 1.

By virtue of the invention, the control unit calculates the current and the driving frequency for the first converter based on measurements of parameters of the electrical signal flowing between the alternator and the first converter. The installation does not require a mechanical sensor to detect the position of the rotor of the alternator relative to the stator of the alternator, thereby reducing risks of failure. In addition, the method uses parameters, such as inductances of electrical components of the installation, which are not sensitive to variations in temperature. The method of the invention provides for starting up the installation. The calculations performed by the control unit are relatively simple. Consequently, the method is simple to program and does not require significant computational resources.

Advantageous aspects, but which are not mandatory, of such a method are defined in claims 2 to 11.

The invention relates also to an installation for the conversion of mechanical energy into hydraulic energy, as defined in claim 12.

The invention will be better understood and other advantages thereof will become clearer in the light of the following description of an installation for the conversion of mechanical energy into electrical energy and of a method for driving the installation, given purely by way of example and with reference to the accompanying drawings in which:

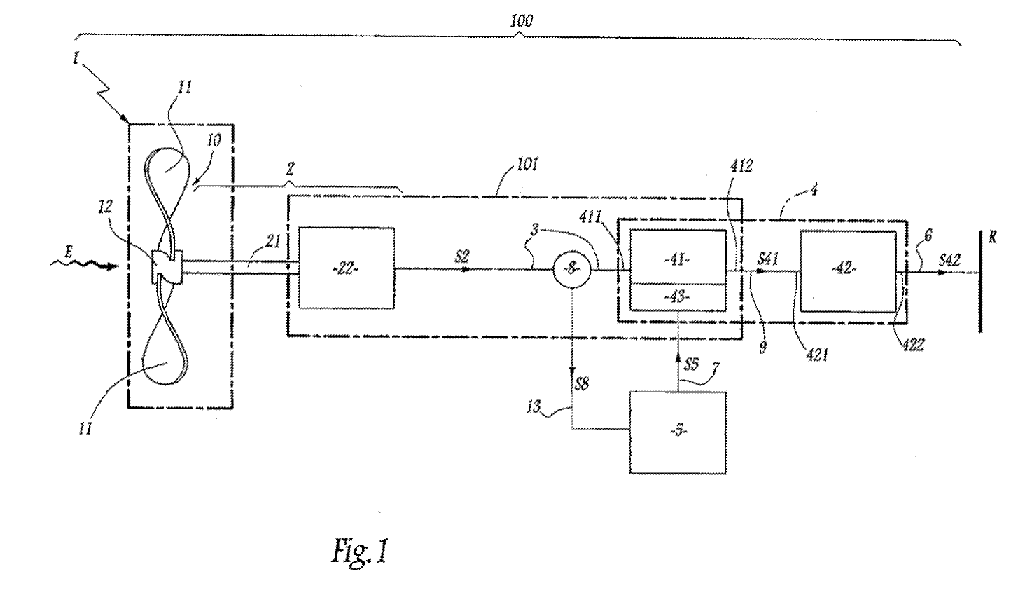

FIG. 1 is a diagram representing an energy conversion installation in accordance with the invention: and

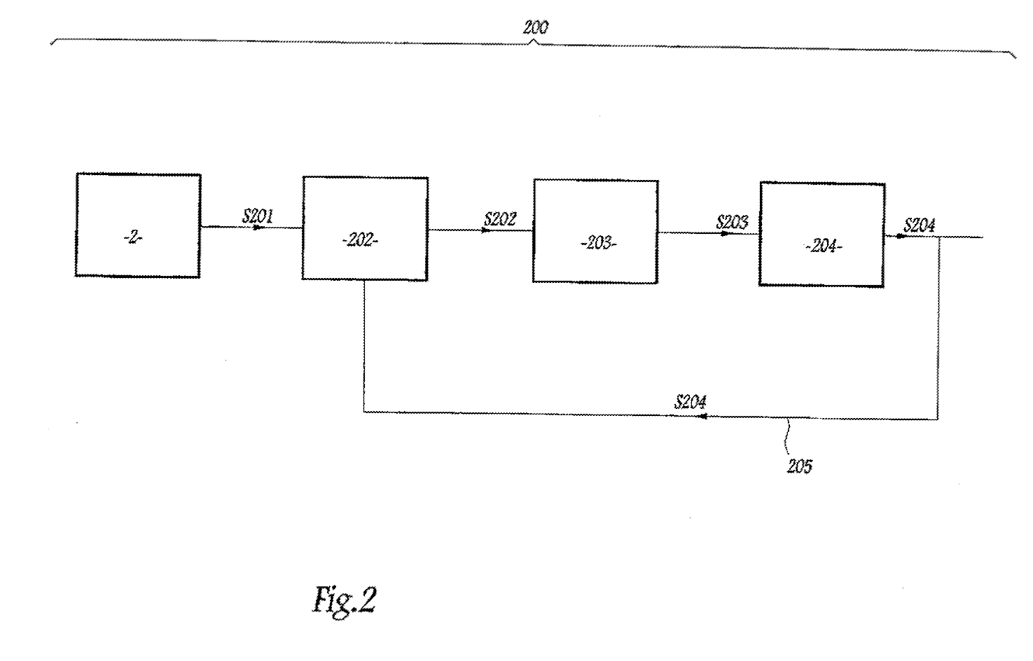

FIG. 2 is a block diagram of the structure of a method in accordance with the invention.

FIG. 1 schematically represents an installation 100 for converting hydraulic energy into electrical energy. The installation 100 comprises a marine turbine 1, an alternator 2, a converter 4 and a control unit 5.

The marine turbine 1 is an underwater turbine which operates by virtue of the energy of a flow of water or sea currents. The marine turbine 1 comprises a propeller 10 which is rotatably movable with respect to a fixed shroud, not represented. The propeller 10 comprises blades 11 which are fixed to a hub 12. When in operation, a flow of water E rotatably drives the propeller 10.

The alternator 2 is a three-phase synchronous electrical machine which comprises a rotor 21 and a stator 22. The rotor 21 comprises a magnetic circuit with permanent magnets which produce a constant magnetic field F21. The stator 22 comprises three coils. The terminals of the stator 22 are electrically connected to a first end of an electric cable 3 comprising three conductors insulated from one another.

The rotor 21 of the alternator 2 is mechanically coupled to the hub 12 of the marine turbine 1, so that when the flow E rotatably drives the propeller 10 of the marine turbine 1, the rotation movement of the hub 12 of the marine turbine 1 is wholly transmitted to the rotor 21 of the alternator 2. When the rotor 21 turns, the magnetic field F21 created by the rotor 21 successively passes in front of the coils of the stator 22 and induces a voltage across the terminals of each coil of the stator 22. Thus, the alternator 2 generates a three phase sinusoidal electrical signal 52 of frequency f2 conveyed up to the input of the converter 4 by means of the electric cable 3. The alternator 2 thus converts the mechanical power into electrical power.

An electrical signal is defined by parameters including the intensity of its current, the level of its voltage and, in the case of an AC signal such as a sinusoidal signal, its frequency, which is the same for the current and the voltage, and the phase between the current and voltage, i.e. the angle of phase difference between the current and the voltage. Hereafter, the intensity of the current is denoted by the term “current” and the level of the voltage is denoted by the term “voltage”.

The converter 4 comprises a rectifier 41, the input 411 of which is connected to a second end of the electric cable 3, and the output 412 of which is connected to the input 421 of an inverter 42 by means of an electric cable 9 provided to transport a DC electrical signal S41 delivered by the rectifier 41. The rectifier 41 thus transforms the sinusoidal electrical signal S2 into a DC electrical signal S41. Then, the inverter 42 transforms the DC electrical signal S41 into a sinusoidal electrical signal S42 which is transported by an electric cable 6 intended to be connected to the electrical distribution network R. The frequency fR of the electrical network R is fixed. For example, in Europe, the frequency fR is equal to 50 Hz. In practice, electronic components, not represented, can be placed between the inverter 42 and the rectifier 41.

The rectifier 41 and the inverter 42 are static electrical energy converters which do not provide for increasing the power of the signal S2. In practice, they can be IGBT transistor bridges which switch between an on-state and an off-state in order to modify the parameters of the electrical signals S2, S41 and S42. According to the conventions used, the rectifier 41 can be denoted by the term “inverter” and the inverter 42 can be denoted by the term “rectifier”.

The inverter 42 operates autonomously and the electrical signal S42 which it delivers exhibits a fixed frequency f42. The inverter 42 is not driven by the control unit 5. The inverter 42 is configured so that the frequency f42 is equal to the frequency fR of the electrical network R. For example, in Europe, a frequency f42 equal to 50 Hz will be chosen, so as to be able to connect the installation 100 to the electrical network R.

The frequencies f2 and f42 of the signals S2 and S42 are dissociated. In other words, the frequencies f2 and f42 are independent of one another.

An electric cable 7 connects the control unit 5 to the microcontroller 43. The control unit 5 controls the rectifier 41 via a microcontroller 43 which regulates the state of the electronic components which form the rectifier 41 as a function of a control, signal S5 delivered by the control unit 5 and flowing in the electric cable 7. In practice, the microcontroller 43 forms part of the rectifier 41. The rectifier 41 modifies certain parameters of the signals 32 and S41 as a function of the control signal S5, in particular the current I2 and of the frequency f2 of the signal S2.

When in service, the control unit 5 generates the control signal S5 which contains information relating to a driving frequency fp and a driving current Ip, which are obtained by means of the method of the invention. The driving frequency fp and the driving current Ip are setpoints for the frequency f2 and the current I2 of the signal S2. The microcontroller 43 receives the signal S5 and drives the rectifier 41 in such a way that, on the one hand, the driving frequency fp is equal to the frequency f2 of the sinusoidal signal S2 and, on the other hand, the current I2 of the sinusoidal signal S2 is equal to the driving current Ip.

The aim of the method of the invention is to determine the driving frequency fp and the driving current Ip in order that the electrical power generated by the installation 100 is maximum, so as to optimize the efficiency of the installation 100.

In a synchronous machine such as the alternator 2, the rotoric electromagnetic field F21 constantly tries to align itself on the statoric electromagnetic field F22, just like the magnetized needle of a compass which aligns itself on the terrestrial magnetic field. However, the terrestrial magnetic field is fixed while the statoric electromagnetic field F22 turns with a rotation frequency f(F22) proportional to the frequency f2 of the electrical signal S2 at the terminals of the stator 22. In order that the alternator 2 operates, it is necessary to satisfy a first condition A according to which the electromagnetic fields F21 and F22 turn at the same rotation frequency.

In a synchronous machine, the rotation frequency f21 of the rotor 21 is equal to the rotation frequency f(F21) of the rotoric electromagnetic field F21.

The number of pairs of poles of the alternator 2 is denoted by p. In the case of synchronous machines, the relationship between the frequency f21 and the frequency f2 is the following: f2=p·f21. Thus, the frequencies f21 and f2 are proportional.

When in service, the rectifier 41 modifies the parameters of the signal S2, in particular the current I2, so as to modulate an electromagnetic braking torque T which the rotor 21 of the alternator 2 applies to the hub 12 of the propeller 10. By making the intensity of the braking torque T vary, the rectifier 41 makes the rotation frequency f21 of the propeller 10 vary as well as the frequency f(F21) of the rotoric electromagnetic field F21.

According to a second condition B, the angle Ψ between the statoric electromagnetic field F21 and the rotoric electromagnetic field F22 is nil. When the angle Ψ is nil and remains held constant and equal to zero, the frequency f(F21) of the rotoric field F21 is bound to be equal to the frequency f(F22) of the statoric magnetic field. If the second condition B is satisfied, the first condition A is verified.

For a given current I2, when the second condition B is verified, then the intensity of the electromagnetic torque T is maximum, thereby implying that the installation 100 is operating at its optimal operation point. Specifically, the torque T results from the interaction between the electromagnetic fields F21 and F22 and it is maximum when the angle Ψ between the electromagnetic fields F21 and F22 is nil since the electromagnetic torque T is proportional to the cosine of the angle Ψ multiplied by the intensity of the current I2 delivered by the alternator 2. The angle Ψ is the phase difference of the statoric electromagnetic field F21 with respect to the rotoric electromagnetic field F22.

When a unique third condition C is satisfied, then the second condition B is true. The third condition C concerns reactive power.

In an AC electrical circuit, power is expressed in a particular way due to the periodic nature of the functions manipulated. It is possible to determine several quantities homogeneous with powers: active power, reactive power and apparent power.

The active power of a component, denoted by P and expressed in watts, corresponds to the average power developed by the component over a period. The active power P is the power available to perform work. In the case of a three-phase electrical signal, the active power P is given by the relationship P=3·V·I·cos φ. V is the voltage between a phase of the three-phase signal and neutral. The angle φ corresponds to the phase difference between the voltage V and the current I of the three-phase electrical signal.

The reactive power, denoted by Q and expressed in volt-ampere reactive (var), is given by the relationship Q=3·V·I·sin φ, in the case of a three-phase electrical signal.

Lastly, apparent power, denoted by S and expressed in volt-ampere (VA), is obtained by the relationship S²=P⁴Q² and is equal to 3·V·I.

Dipoles of purely capacitive or purely inductive type have an active power P of nil and a reactive power Q equal to their apparent power S. Thus, the reactive power Q can be used to assess the significance of capacitive and inductive receivers of an AC electrical circuit.

There are other ways to calculate active, reactive and apparent power. As a variant, these powers are calculated by performing a change of reference which provides for switching from a three-dimensional reference (a, b, c), which corresponds to the three phases of the three-phase electrical signal, to a two-dimensional reference (d, q, 0). Transforms such as the Park transformation or the Clarke transformation provide for performing such a change of reference. For example, in the case of the Park transformation, the reference (d, q, 0) is rotating and turns at the same rotation frequency as the frequency of the three-phase signal. Thus, in the reference (d, q, 0), the level of the voltage and the intensity of the current of the three-phase electrical signal are constant. These transformations use a (3, 3) dimension matrix in which an angle θ features. In the case of the Park transformation, the d axis can be defined by the magnets of the rotor 21 of the alternator 2 and the q axis can be defined by the open-circuit voltage E2 of the alternator 2, the voltage E2 being out of phase by π/2 with respect to the permanent magnets of the rotor 21. The angle θ can be obtained by integrating the driving frequency fp. In the case of the Park transformation, the reactive power Q can be expressed as follows:

Q=Vd·Iq−Vq−Id,

where Vd and Vq are the voltage level on the d and q axes and Id and Ig are the intensity of the current on the d and q axes.

It is also possible to calculate the active, reactive and apparent powers by means of the angle Ψ between the statoric electromagnetic field F21 and the rotoric electromagnetic field F22, in particular by means of the sine of the angle Ψ.

According to the third condition C, the setpoint value Q2em.c of the electromagnetic reactive power Q2em supplied by the alternator 2 is nil. The electromagnetic reactive power Q2em corresponds to the magnetization work of the alternator 2.

The values referred to as “instantaneous” of any variable are obtained from measurements of this variable and can vary over time. The instantaneous value characterizes the variable at a given instant corresponding to the instant at which the measurement is carried out. The values referred to as “setpoint” of a variable are the theoretical values that it is desired to give to this variable.

The method of the invention consists in driving the rectifier 41 in order that it imposes the third condition C, such that the instantaneous values of certain variables be equal to the setpoint values of these variables. However, the instantaneous value Q2em.i of the electromagnetic reactive power Q2em is not directly accessible, nor measurable, but it can be determined, based on measurements, by calculations, the principle of which is explained below.

By virtue of the invention, the rectifier 41 cancels and maintains at zero the instantaneous value Q2em.i of the electromagnetic reactive power Q2em consumed or supplied by the alternator 2.

In a subsystem 101 made up of the alternator 2, the cable 3 and the rectifier 41, the sum of the reactive powers produced or consumed Q101 is nil since there cannot be an exchange of reactive power outside the subsystem 101. Specifically, the alternator 2 cannot exchange reactive power with the marine turbine 1, since the marine turbine 1 is not an electrical item, and the rectifier 41 cannot exchange reactive power with the electric cable 9 transporting the DC signal S41, since reactive power has no meaning in a DC environment.

According to the Boucherot theorem applied to the subsystem 101, the total reactive power Q101 of the subsystem 101 is equal to the sum of the reactive powers of each electrical component of the subsystem 101, giving the relationship (R1):

Q101=Q2em+Q2+Q3+Q41,

where Q2em is the electromagnetic reactive power supplied or consumed by the alternator 2, Q2 is the reactive power consumed by the coils of the stator 22 of the alternator 2, Q3 is the reactive power consumed by the line inductances of the electric cable 3 and Q41 is the reactive power supplied or consumed by the rectifier 41.

The relationship (R1) considers an inductive cable 3. The same equation could be established by taking into account the reactive power produced by the capacitances of the cable, if the cable were capacitive in nature.

Given that Q101 is always nil by definition, the relationship (R) becomes the relationship (R2):

Q2em=−Q2−Q3−Q41,

As explained in greater detail below, the relationship (R2) provides for determining the instantaneous value Q2em.i of the reactive power Q2em, from instantaneous values Q41.i, Q2.i and Q3.i of the reactive powers Q41, Q2 and Q3, obtained from measurements.

The control unit 5 then calculates the value of the driving current Ip of the driving frequency fp of the rectifier 41 as a function of the difference between the instantaneous value of Q2em.i and the setpoint value Q2em.c of the reactive power Q2em. Thus, the control unit 5 drives the rectifier 41 in order that the third condition C be satisfied, thereby providing for modifying the operation of the installation 100 so as to achieve a maximum efficiency.

The method of the invention operates by virtue of an algorithm, the main objective of which is to stabilize and improve the reaction of the installation 100 with respect to the control signal S5 which forms a setpoint. In this way, the installation 100 is controlled.

The calculation steps belonging to the method of the invention and described below are successive; they take place one after the other and are repeated in a loop when the installation 100 is operating.

The control unit 5 determines the instantaneous value Q2em.i of the electromagnetic reactive power Q2em supplied or consumed by the alternator 2, by means of the relationship (R2):

Q2em=−Q2−Q3−Q41.

To achieve this, in a first step 2001, the control unit determines the instantaneous values Q2.i and Q3.i of the reactive powers Q2 and Q3 of the alternator 2 and of the electric cable 3. For example, the control unit 5 can use the definition of reactive power: Q=3·V·I·sin φ. The voltage drop in the coils of the alternator 2 is equal to the impedance of the alternator 2 multiplied by the current which passes through the alternator 2. Now, the impedance of the alternator 2 is by nature mainly inductive and is obtained by multiplying the line inductance L2 of the alternator 2, expressed in H, by the angular frequency of the sinusoidal electrical signal at the terminals of the alternator 2.

Similarly, the impedance of the electric cable 3 is considered to be inductive and is obtained by multiplying the line inductance L3 of the electric cable 3 by the angular frequency of the sinusoidal electrical signal which flows in the electric cable 3.

Since the impedances of the alternator 2 and the electric cable 3 are purely inductive, they are not sensitive to variations in temperature.

In a known way, the argument φ of a purely inductive impedance, which corresponds to the phase difference between the voltage V and the current I of the electrical signal passing through this impedance, is equal to π/2. Moreover, the angular frequency is equal to the frequency of the signal, multiplied by 2π.

Thus, Q2=3·(L2)·2π·f2·I2² and Q3=3·(L3)·2π·f2·I2².

In order to determine the instantaneous values Q2.i and Q3.i, it is necessary to have instantaneous values f2.i and I2.i of the frequency f2 and of the current I2.

These instantaneous values I2.i and f2.i can be obtained in many alternative ways. First, it is possible to use a sensor 8 which measures the current I2 of the signal S2 and transmits this information to the control unit 5 by means of a signal S8 which flows in an electric cable 13 which connects the sensor 8 to the control unit 5. The control unit 5 deduces an instantaneous value f2.i of the frequency f2 of the signal S2 from the instantaneous value I2.i of the current I2. As an alternative, instantaneous values I2.i and f2.i are obtained by the rectifier 41 which, internally, measures the current I2 and the frequency f2.

Conventionally, the line inductances L2 and L3 of the alternator 2 and of the electric cable 3 are given by the manufacturer or are calculated from numerical models. The line inductances L2 and L3 are not affected significantly by variations in external parameters such as temperature. It is sufficient to determine only once the inductances L2 and L3, for example during a test step.

In a second step 2002, the control unit 6 determines an instantaneous value Q41.i of the reactive power Q41 of the rectifier 41. In a known way, the reactive power Q41 is given by the relationship Q41=3·V2·I2·sin(φ2). The instantaneous value I2.i of the current I2 is determined according to the alternatives explained above. There are several ways for obtaining the instantaneous value V2.i of the voltage V2.

In a first alternative, the voltage V2 is known by the microcontroller 43 since the microcontroller 43 sets the value of the AC voltage V2 at the input 411 of the rectifier 41. Thus, the microcontroller 43 possesses an internal data item relating to this voltage V2. By considering that the rectifier 41 does not produce an error in delivering the voltage V2, an estimate of the instantaneous value V2.i of the voltage V2 is obtained. Consequently, it of always necessary to measure the voltage V2. As an alternative, the rectifier 41 can measure, internally, this voltage V2 using a voltage sensor,

In a second alternative, the sensor 8 measures the instantaneous value V2.i of the voltage V2.

The instantaneous value φ2.i of the phase difference φ2 is deduced directly from measurements of the current I2 and of the voltage V2.

Thus, at the end of the second step 2002, an instantaneous value Q41.i of the reactive power Q41 supplied or consumed by the rectifier 41 is known.

Other approaches can be used to determine an instantaneous value Q41.i of the reactive power 41.

In a third step 2003, the control nit 5 determines the instantaneous value Q2em.i of the electromagnetic reactive power Q2em, by means of the relationship (R2) Q2em.i=−Q2.i−Q3.i−Q41.i, from the reactive powers determined at steps 2001 and 2002.

In order that the third condition C be satisfied, the instantaneous value Q2em.i of the electromagnetic reactive power Q2em must be nil. Moreover, given that Q101=0, when Q2em=0, then the relationship (R1) is equivalent to the relationship (R3) Q41=−(Q2+Q3). Thus, the rectifier 41 must increase or reduce by Q2em.i its reactive power Q41 so as to re-establish equality between Q41 and −(Q2+Q3). The variation of the reactive power Q41 of the converter 4 corresponds both to a variation of the angle of phase difference φ2 between the current I2 and the voltage V2 and to a variation of the angle Ψ between the electromagnetic fields F21 and F22.

In a fourth step 2004, the control unit 5 divides the instantaneous value Q2em.i of the electromagnetic reactive power Q2em, determined during the third step 2003, by the instantaneous apparent power S2.i of the alternator 2, given for example by the relationship S2.i=3·V2.i·I2.i. The instantaneous values V2.i and I2.i of the voltage V2 and of the current I2 are determined as explained above. The result of this division gives an instantaneous error ε.i which is unitless, thereby providing for facilitating the calculations and the adjustment of the regulator. Specifically, the instantaneous error ε.i varies between 0 and 1. When the instantaneous error ε.i is nil, the installation 100 operates at its maximum efficiency and the electromagnetic fields F21 and F22 are in phase. When the instantaneous error ε.i is equal to 1, the angle Ψ between the electromagnetic fields F21 and F22 is equal to π/2 and the installation 100 does not produce electrical energy.

Thus, the instantaneous error ε.i is proportional, in the mathematical sense of the term, to the instantaneous value Q2em.i of the electromagnetic reactive power Q2em. Moreover, in accordance with the relationship Q2em.i=−Q2.i−Q3.i−Q41.i (R2), the instantaneous value Q2em.i of the electromagnetic reactive power Q2em is equal to the opposite of the sum of the measured values Q2.i, Q3.i and Q41.i of the reactive power Q2 of the alternator 2, the reactive power Q3 of the electric cable 3 and the reactive power Q41 of the first converter 41.

Consequently, the instantaneous error ε.i is determined as a function of the reactive power Q41 of the first converter 41. In particular, the instantaneous error ε.i and the reactive power Q41 are related through the relationship:

$$ɛ \cdot i = \frac{- Q 2 \cdot i - Q 3 \cdot i - Q 41 \cdot i}{S 2 \cdot i}$$

On the other hand, the instantaneous error ε.i is determined from the measured value I2.i of the current I2 of the electrical signal S2 since the measured value I2.i of the current I2 features in the calculation of the measured values Q2.i, Q3.i and Q41.i of the reactive power Q2 of the alternator 2, the reactive power Q3 of the electric cable 3 and the reactive power Q41 of the first converter 41.

The fourth step 2004 is optional. In that case, the instantaneous error ε.i is equal to the measured value Q2em.i of the reactive power Q2em of the alternator 2. Consequently, the instantaneous error ε.i is than homogeneous with the reactive power Q41 of the first converter 41, since these two quantifies have the same unit; these are reactive powers, expressed in volt-ampere (VA).

As a variant, the instantaneous error ε.i is proportional to the measured value Q41.i of the reactive power Q41 or proportional to the image of the measured value Q41.i of the reactive power Q41 via a mathematical function, in particular the arcsine or inverse sine function.

In a first preliminary step 1001, the value of a setpoint error ε.c is implemented in the control unit 5. The setpoint error ε.c is equal to the setpoint value Q2em.c of the electromagnetic reactive power Q2em, divided by the maximum apparent power S2 of the alternator 2. Thus, the setpoint error ε.c is proportional to the setpoint value Q2em.c of the electromagnetic reactive power Q2em.

The method comprises a main step 3000 in which the control unit 5 determines the driving frequency fp and the driving current Ip.

During a first substep 2005 of the main step 3000, the control unit 5 determines a final error ε equal to the difference between the setpoint error ε.c and the instantaneous error ε.i. The setpoint error ε.c is the theoretical value that it is desired to give to the instantaneous error ε.i.

The setpoint value Q2em.c is fixed at a nil value, according to the third condition C. Consequently, the final error ε is equal to the instantaneous error ε.i.

The final error ε is the input data for a corrector of the predetermined proportional-integral regulator type.

In a second substep 2006 of the main step 3000, the control unit 5 determines a frequency difference Δf as a function of the final error ε. The method of the invention comprises a second preliminary step 1002 in which the user defines the constants Kp and Ki of the proportional-integral regulator. By integrating the final error ε, the proportional-integral regulator delivers as output the frequency difference Δf which corresponds to the difference between the instantaneous frequency f2.i of the signal S2 and theoretical frequency which the signal S2 should have in order that the condition C be verified.

In a third substep 2007 of the main step 3000, the control unit 5 calculates the driving frequency fp by adding a frequency ramp fr or a fixed frequency fe to the frequency difference Δf, depending on the operating state of the installation 100. The frequency ramp fr is entered into the control unit 5 and is determined in the third preliminary step 1003 in order to be close to the ideal startup of the installation 100, i.e. a startup in which the rotation frequency f21 of the propeller 10 of the marine turbine 1 increases so as to obtain a fast startup, but not too fast so as not to risk a loss of synchronism. The fixed frequency fe is also determined during the third preliminary step 1003 and corresponds to the average frequency of the signal S2 when the installation 100 operates in the steady state, under standard conditions, for example at the start of the production cycle.

During startup phases of the installation 100, the rectifier 41 sets the rotation frequency f21 of the propeller 10, according to the frequency ramp fr. Thus, the propeller 10 rapidly reaches a frequency referred to as the “generation” frequency, from which the installation 100 begins to produce electrical energy. Henceforth, the frequency ramp fr is replaced by the fixed frequency fe. The third substep 2007 is optional and when it is removed, the driving frequency fp is determined by adding the frequency difference Δf and the instantaneous frequency f.i.

In a fourth substep 2008 of the main step 3000, the control unit 5 determines the driving intensity Ip with the aid of a table of predetermined data D indicating the intensity I2 of the signal S2 as a function of the frequency f2 of the signal S2, in order that the marine turbine 1 operates at its optimal operating point. The optimal operating point enables the marine turbine 1 to retrieve a maximum of mechanical energy based on the parameters of the flow E. This data D is entered into the control unit 5 during a fourth preliminary step 1004 according to the hydraulic characteristics of the marine turbine 1 and the characteristics of the alternator 2. The data D can be deduced from another table of values indicating the maximum torque of the propeller 10 as a function of the rotation frequency f21 of the hub 12 of the propeller 10. The intensity I2 of the signal S2 is proportional to the electromagnetic torque T, and the rotation frequency f21 of the propeller 10 is proportional to the frequency f2 of the signal S2.

In a driving step 4000, the control unit 5 transmits the signal S5 relating to the driving frequency fp and to the driving current Ip to the microcontroller 43 which drives the rectifier 41 so that the frequency f2 of the signal S2 is equal to the driving frequency fp and so that the current I2 of the signal S2 is equal to the driving current Ip.

The control unit 5 repeats in a loop the steps described above during the operation of the installation 100. For example, the control unit 5 can repeat the steps with a frequency corresponding to an automatic control cycle time, for example 2 ms.

The driving method of the invention substantially exhibits a phase-lock loop (PLL) structure 200, represented in FIG. 2.

In a known way, the phase-lock loop 200 includes an input signal S201 with variable frequency, a phase detector 202 which generates an error signal S202 proportional to the phase difference between the input signal S201 and an output signal S204 of the phase-lock loop 200, a low-pass filter 203 and a voltage-controlled oscillator, or VCO, 204 which delivers a signal S204, the frequency of which depends on the error signal S202.

The phase-lock loop 200 provides for preserving an equality of frequency and phase between the input S201 and output S204 signals.

According to the invention, the signal S2 corresponds to the input signal S201. The frequency f2 depends on the rotation frequency f21 of the propeller 10. The measurement of the reactive power provides the function of the phase detector 202. The low-pass filter 203 is formed by the proportional-integral regulator and the converter 4 provides the function of the voltage-controlled oscillator 204.

Unlike a conventional phase-lock loop in which the frequency of the input signal S201 is independent of the frequency of the output signal S204, the structure used for the method of the invention has a feedback loop 205 which transmits the output signal S204 to the phase detector 202. This feedback loop 205 represents a direct physical link between the rotation frequency f21 of the propeller 10 and the frequency f2 of the signal S2.

Specifically, the frequency f2 of the signal S2, and therefore also the rotation frequency f21 of the propeller 10, are dependent physically on the electromagnetic torque T delivered by the converter 4. If the torque T reduces, then the frequencies f2 and f21 also reduce, and vice versa.

By virtue of the feedback loop 205, the installation 100 is controlled. The method controls the installation 100 by negative feedback.

As a variant, the installation 100 is an installation for converting wind energy into electrical energy. In that case, a wind turbine replaces the marine turbine 1.

In another variant, the marine turbine 1 can be replaced by a hydraulic turbine.

As a variant, not represented, the sensor 8 is removed. This is because the intensity of the current I2 and the voltage level V2 are measured directly by internal sensors of the rectifier 41. In that case, the microcontroller 43 transmits this data to the control unit 5.

As a variant, the second condition B is verified when the angle is constant and not nil. When the angle Ψ is not zero, the third condition C is satisfied when the electromagnetic reactive power Q2em of the alternator 2 is not nil, which means that the electrical components of the installation 100 can be demagnetized. Thus, the efficiency of the installation 100 is improved. In this variant, during the first preliminary step 1001, the user defines a setpoint error ε.c which corresponds to a non-zero electromagnetic power Q2em of the alternator 2. In practice, a setpoint angle Ψc between −60° and +60° will be chosen, preferably between −30° and +30°. Specifically, if the angle Ψ is too large, then the alternator 2 does not operate at its optimal operating point and the efficiency of the installation 100 is degraded.

In another embodiment, during the main step 3000, the control unit 5 calculates the driving current Ip and the driving frequency fp as a function of a different variable of the final error ε and obtained from a measurement of the intensity of the current I2. This variable, which replaces the final error ε, is proportional to or homogeneous with a reactive power and corresponds to the input of the proportional-integral regulator. For example, the variable can be the angle Ψ between the statoric electromagnetic field F21 and the rotoric electromagnetic field F22, a variable homogeneous with or proportional to the angle Ψ, the sine of the angle Ψ or a variable homogeneous with or proportional to the sine of the angle Ψ. However, the reactive power can be expressed as a function of an angle that is different from the angle Ψ. For example, as an alternative, the variable can be the angle φ2 of the phase difference between the voltage V2 and current I2 of the signal S2, a variable proportional to or homogeneous with the angle φ2, the sine of the angle φ2 or a variable homogeneous with or proportional to the sine of the angle φ2. The reactive power is expressed as a function of the sine of the angle Ψ and therefore provides for knowing the sign of the angle Ψ, which is not necessarily the case for other quantities. The sign of the angle Ψ determines whether the rectifier 41 must supply or consume the reactive power in order that the third condition C be satisfied. As a variant, the alternator 2 is an asynchronous machine.

As a variant, not represented, the installation 100 comprises at least one transformer inserted between the alternator 2 and the converter 4 and in particular providing for adapting the level of the voltage of the signal S2 delivered by the alternator 2, to the voltage constraints imposed by the converter 4. It is possible to place two transformers between the alternator 2 and the converter 4. The first transformer increases the level of the voltage V2 of the signal S2 and lowers the intensity of the current I2 of the signal S2. Consequently, losses through the Joule effect in the electric cable 3 are reduced. Then, a second transformer placed between the electric cable 3 and the input 411 of the rectifier 41 reduces the level of the voltage V2 and increases the intensity of the current I2 to re-establish the signal S2.

As a variant, the proportional-integral corrector is replaced by another type of element, insofar as this element provides for determining a frequency difference as a function of a setpoint signal that is homogeneous with or proportional to a reactive power.

The mathematical expressions given in the present description can be modified depending on the electrical components present in the installation.

Additionally, in the context of the invention, the various embodiments and variants described above can be combined with each other, fully or partly.

1. A method for regulating the power of an installation (100) for the conversion of mechanical energy into electrical energy, the installation (100) comprising:
a machine (1) comprising a rotary mechanical receiver (10) intended to be traversed by a flow (E),
an alternator (2), the rotor (21) of which is connected to a hub (12) of the rotary mechanical receiver (10),
a first converter (41) which converts a first three-phase electrical signal (S2) delivered by the alternator (2) into a second, DC, electrical signal (341),
an electric cable (3) which connects the terminals of a stator (22) of the alternator (2) to an input (411) of the first converter (41),
a second converter (42), an input (421) of which is electrically connected to an output (412) of the first converter (41) and an output (422) of which is intended to be connected to an electrical distribution network (R), the second converter (42) converting the second electrical signal (S41) into a third, AC, electrical signal (S42) having a fixed frequency (f42),
means (8, 41, 43) for measuring the current (I2) of the first electrical signal (S2),
a control unit (5) programmed to control the first converter (41) by transmitting to it a driving frequency (fp) and a driving current (Ip), the first converter (41) modulating the frequency (f2) and the current (I2) of the first electrical signal (S2) so that the driving frequency (fp) is equal to the frequency (f2) of the first electrical signal (S2), and so that the current (I2) of the first electrical signal (S2) is equal to the driving current (Ip), the method comprising: a first preliminary step (1001) in which the value of a setpoint quantity (ε.c) proportional to a reactive power is implemented in the control unit;
a main step (3000) in which the control unit (5) determines the driving frequency (fp) and the driving current (Ip) from an error (ε) equal to the difference between the setpoint quantity (ε.c) and an instantaneous quantity (ε.i) which is at the same time homogeneous with the setpoint quantity (ε.c), dependent on the reactive power (Q41) of the first converter (41) and determined from a measured value (I2.i) of the current (I2) of the first electrical signal (S2).

2. The method as claimed in claim 1, characterized in that the instantaneous quantity (ε.i) and the reactive power (Q41) of the first converter (41) are related via the relationship:
$$ɛ \cdot i = \frac{- Q 2 \cdot i - Q 3 \cdot i - Q 41 \cdot i}{S 2 \cdot i} ,$$
where
Q2.i is a measured value of the reactive power (Q2) of the alternator (2),
Q3.i is a measured value of the reactive power (Q3) of the electric cable (3),
Q41.i is a measured value of the reactive power (Q41) of the first converter and
S2.i is a measured value of the apparent power (S2) of the alternator (2).

3. The method as claimed in claim 1, characterized in that the instantaneous quantity (ε.i) is proportional to or homogeneous with the reactive power (Q41) of the first converter (41).

4. The method as claimed in claim 1, characterized in that the error (ε) is proportional to a first angle (Ψ) between a rotoric electromagnetic field (F21) of the alternator (2) and a statoric electromagnetic field (F22) of the alternator (2) or proportional to the sine of the first angle (Ψ).

5. The method as claimed in claim 1, characterized in that the error (ε) is proportional to an angle of phase difference (φ2) between the current (I2) of the first electrical signal (S2) and the voltage (V2) of the first electrical signal (S2), or proportional to the sine of the angle of phase difference (φ2).

6. The method as claimed in one of the preceding claims, characterized in that it additionally comprises a first step (2001), prior to the main step (3000), in which the control unit (5) determines:
a measured value (Q2.i) of the reactive power (Q2) of the alternator (2), from an inductance (L2) of the alternator (2);
a measured value (Q3.i) of the reactive power (Q3) of the electric cable (3), from an inductance (L3) of the electric cable (3).

7. The method as claimed in one of the preceding claims, characterized in that additionally comprises a second step (2002), prior to the main step (3000), in which the control unit (5) determines a measured value (Q41.i) of the reactive power (Q41) of the first converter (41) from a measured value (I2.i) of the current (I2) of the first electrical signal (S2).

8. The method as claimed in claims 4 and 5, characterized in that it additionally comprises a third step (2003) in which the control unit (5) determines a measured value (Q2em.i) of the electromagnetic reactive power (Q2em) of the alternator (2) from the measured value (Q41.i) of the reactive power (Q41) of the first converter (41), from the measured value (Q2.i) of the reactive power (Q2) of the alternator (2) and from the measured value (Q3.i) of the reactive power (Q3) of the electric cable (3).

9. The method as claimed in one of the preceding claims, characterized in that it comprises a second preliminary step (1002) in which at least one constant (Kp, Ki) of a corrector is defined, the output of which is a frequency difference (Δf) and the input of which is the error (ε), in that the main step (3000) comprises a first substep (2006) in which the control unit (5) determines, by means of the corrector, the frequency difference (Δf) as a function of the error (ε) and in that during the main step (3000), the driving frequency (fp) is calculated from the frequency difference (Δf).

10. The method as claimed in one of the preceding claims, characterized in that it additionally comprises a third preliminary step (1003) in which the user enters into the control unit (5) a frequency ramp (fr) or a fixed frequency (fe) and in that the main step (3000) comprises a second substep (2007) in which the control unit (5) determines the driving frequency (fp) of the first converter (41) by adding the frequency difference (Δf) and the frequency ramp (fr) or the fixed frequency (fe).

11. The method as claimed in one of the preceding claims, characterized in that it comprises a fourth preliminary step (1004) in which the user enters into the control unit (5) predefined data (D), which correspond in particular to an optimal efficiency of the machine (1), from which data the driving current (Ip) as a function of the driving frequency (fp) and in that the main step (3000) comprises a third substep (2008) in which the control unit (5) determines the driving current (Ip) as a function of the predefined data (D) and of the driving frequency (fp).

12. An installation (100) for the conversion of mechanical energy into hydraulic energy, the installation (100) comprising:
a hydraulic machine (1) or wind turbine comprising rotary mechanical receiver (10) intended to be traversed by a flow (E),
an alternator (2), the rotor (21) of which is connected to the hub (12) of the rotary mechanical receiver (10),
a first converter (41) which converts a first three-phase electrical signal (S2) delivered by the alternator (2) into a second, DC, electrical signal (S41),
an electric cable (3) which connects the terminals of a stator (22) of the alternator (2) to an input (411) of the first converter (41),
a second converter (42), an input (421) of which is electrically connected to an output (412) of the first converter (41) and an output (422) of which is intended to be connected to an electrical network (R), the second converter (42) converting the second electrical signal (S41) into a third, AC, electrical signal (S42) having a fixed frequency (f42),
means (8, 41, 43) for measuring the current (I2) of the first electrical signal (S2),
a control unit (5) which controls the first converter (41) by transmitting to it a driving frequency (fp) and a driving current (Ip), the first converter (41) modulating the frequency (f2) and the current (I2) of the first electrical signal (S2) so that the driving frequency (fp) is equal to the frequency (12) of the first electrical signal (S2), and so that the current (I2) of the first electrical signal (S2) is equal to the driving current (Ip), characterized in that the power of the installation (100) is regulated by means of a method according to one of the preceding claims.
